(19) United States
(12) Patent Application Publication
(10) Pub. No.: US 2014/0188996 A1
(43) Pub. Date: Jul. 3, 2014

(54) RAW FABRIC INTERFACE FOR SERVER SYSTEM WITH VIRTUALIZED INTERFACES

(71) Applicant: ADVANCED MICRO DEVICES, INC., Sunnyvale, CA (US)

(72) Inventors: Sean Lie, Los Gatos, CA (US); Gary Lauterbach, Los Altos Hills, CA (US)

(73) Assignee: Advanced Micro Devices, Inc., Sunnyvale, CA (US)

(21) Appl. No.: 13/731,176

(22) Filed: Dec. 31, 2012

(51) Int. Cl. H04L 29/08

(52) U.S. Cl. CPC H04L 67/10
USPC 709/204

(57) ABSTRACT

A server system allows system's nodes to access a fabric interconnect of the server system directly, rather than via an interface that virtualizes the fabric interconnect as a network or storage interface. The server system also employs controllers to provide an interface to the fabric interconnect via a standard protocol, such as a network protocol or a storage protocol. The server system thus facilitates efficient and flexible transfer of data between the server system's nodes.

### BACKGROUND

1. Field of the Disclosure

The present disclosure generally relates to processing systems and more particularly relates to servers having distributed nodes.

2. Description of the Related Art

High performance computing systems, such as server systems, are sometimes implemented using compute nodes connected together by one or more fabric interconnects. The compute nodes execute software programs to perform designated services, such as file management, database management, document printing management, web page storage and presentation, computer game services, and the like, or a combination thereof. The multiple compute nodes facilitate the processing of relatively large amounts of data while also facilitating straightforward build-up and scaling of the computing system. The fabric interconnects provide a backbone for communication between the compute nodes, and therefore can have a significant impact on processor performance.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of a cluster compute server in accordance with some embodiments.

FIG. 2 is a diagram illustrating a configuration of the server of FIG. 1 in accordance with some embodiments.

FIG. 3 illustrates an example physical arrangement of nodes of the server of FIG. 1 in accordance with some embodiments.

FIG. 4 illustrates a compute node implemented in the server of FIG. 1 in accordance with some embodiments.

FIG. 5 illustrates data paths of a virtual network interface and raw fabric interface of the compute node of FIG. 4 in accordance with some embodiments.

FIG. 6. Illustrates device drivers of the compute node of FIG. 4 preparing messages for the virtual network interface and the raw fabric interface in accordance with some embodiments.

FIG. 7 illustrates a network node implemented in the server of FIG. 1 in accordance with some embodiments.

FIG. 8 illustrates a storage node implemented in the server of FIG. 1 in accordance with some embodiments.

FIG. 9 is a flow diagram of a method of using a raw fabric interface at a compute node of a server in accordance with some embodiments.

FIG. 10 is a flow diagram illustrating a method for designing and fabricating an integrated circuit (IC) device in accordance with some embodiments.

### DETAILED DESCRIPTION OF PREFERRED EMBODIMENTS

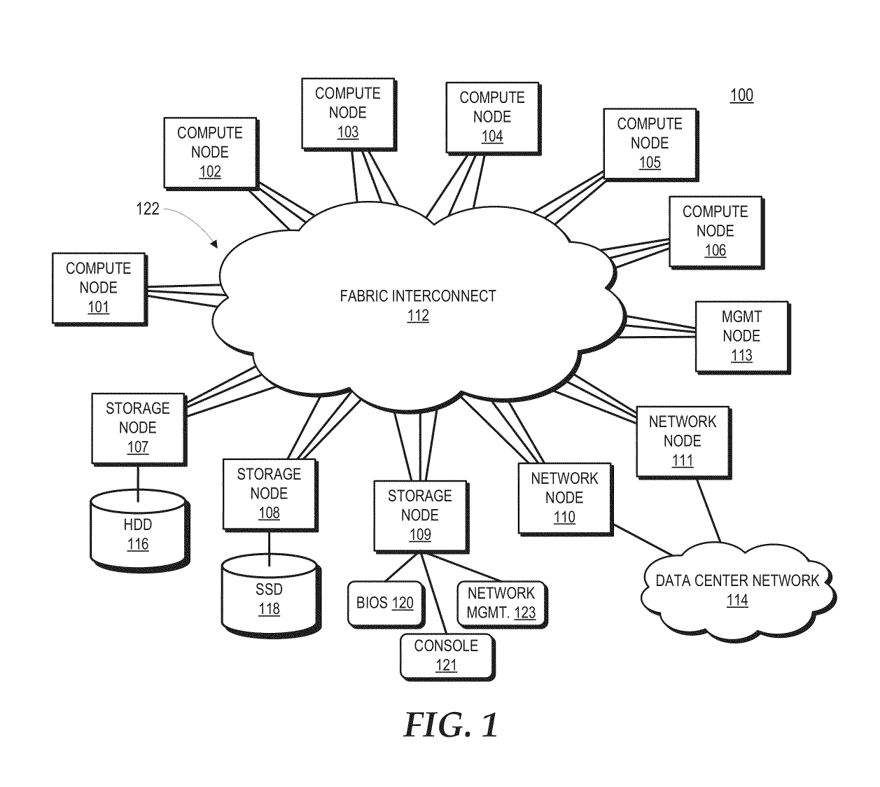

FIGS. 1-10 illustrate example techniques for enhancing performance of compute nodes in a server system by allowing the server system's nodes to access the fabric interconnect of the server system directly, rather than via an interface that virtualizes the fabric interconnect as a network or storage interface. To illustrate, in order to facilitate execution of server operations, each compute node of a server system is configured to perform routing operations to route, via the fabric interconnect, data received from one of its connected nodes to another of its connected nodes according to defined routing rules for the fabric interconnect. Conventionally, the compute node that originates the data for communication (the originating node) employs an interface that virtualizes the fabric interconnect as a network interface or a storage interface. This allows the compute nodes to employ standardized drivers for communication via the fabric interconnect. However, the virtualization of the fabric interconnect can increase communication latency and processing overhead in order to comply with the virtualized communication standard. Accordingly, the originating node can employ a driver or other module that is able communicate with the network fabric directly using the native communication protocol of the fabric interconnect, facilitating more efficient and flexible transfer of data between the server system's nodes.

For ease of illustration, these techniques are described in the example context of a cluster compute server as described below with reference to FIGS. 1-8. Examples of such systems include servers in the SM10000 series or the SM15000 series of servers available from the SeaMicro™ division of Advanced Micro Devices, Inc. Although a general description is described below, additional details regarding embodiments of the cluster compute server are found in U.S. Pat. Nos. 7,925,802 and 8,140,719, the entireties of which are incorporated by reference herein. The techniques described herein are not limited to this example context, but instead may be implemented in any of a variety of processing systems or network systems.

FIG. 1 illustrates a cluster compute server 100 in accordance with some embodiments. The cluster compute server 100, referred to herein as “server 100”, comprises a data center platform that brings together, in a rack unit (RU) system, computation, storage, switching, and server management. The server 100 is based on a parallel array of independent low power compute nodes (e.g., compute nodes 101-106), storage nodes (e.g., storage nodes 107-109), network nodes (e.g., network nodes 110 and 111), and management nodes (e.g., management node 113) linked together by a fabric interconnect 112, which comprises a high-bandwidth, low-latency supercomputer interconnect. Each node is implemented as a separate field replaceable unit (FRU) comprising components disposed at a printed circuit board (PCB)-based card or blade so as to facilitate efficient build-up, scaling, maintenance, repair, and hot swap capabilities.

The compute nodes operate to execute various software programs, including operating systems (OSs), hypervisors, virtualization software, compute applications, and the like. As with conventional server nodes, the compute nodes of the server 100 include one or more processors and system memory to store instructions and data for use by the one or more processors. However, unlike conventional server nodes, in some embodiments the compute nodes do not individually incorporate various local peripherals, such as storage, I/O control, and network interface cards (NICs). Rather, remote peripheral resources of the server 100 are shared among the compute nodes, thereby allowing many of the components typically found on a server motherboard, such as I/O controllers and NICs, to be eliminated from the compute nodes and leaving primarily the one or more processors and the system memory, in addition to a fabric interface device.

The fabric interface device, which may be implemented as, for example, an application-specific integrated circuit (ASIC), operates to virtualize the remote shared peripheral resources of the server 100 such that these remote peripheral resources appear to the OS executing at each processor to be located on corresponding processor's local peripheral bus. These virtualized peripheral resources can include, but are not limited to, mass storage devices, consoles, Ethernet NICs, Fiber Channel NICs, Infiniband™ NICs, storage host bus adapters (HBAs), basic input/output system (BIOS), Universal Serial Bus (USB) devices, Firewire™ devices, PCIe devices, user interface devices (e.g., video, keyboard, and mouse), and the like. This virtualization and sharing of remote peripheral resources in hardware renders the virtualization of the remote peripheral resources transparent to the OS and other local software at the compute nodes. Moreover, this virtualization and sharing of remote peripheral resources via the fabric interface device permits use of the fabric interface device in place of a number of components typically found on the server motherboard. This reduces the number of components implemented at each compute node, which in turn enables the compute nodes to have a smaller form factor while consuming less energy than conventional server blades which implement separate and individual peripheral resources.

The storage nodes and the network nodes (collectively referred to as “peripheral resource nodes”) implement a peripheral device controller that manages one or more shared peripheral resources. This controller coordinates with the fabric interface devices of the compute nodes to virtualize and share the peripheral resources managed by the resource manager. To illustrate, the storage node 107 manages a hard disc drive (HDD) 116 and the storage node 108 manages a solid state drive (SSD) 118. In some embodiments, any internal mass storage device can mount any processor. Further, mass storage devices may be logically separated into slices, or “virtual disks”, each of which may be allocated to a single compute node, or, if used in a read-only mode, shared by multiple compute nodes as a large shared data cache. The sharing of a virtual disk enables users to store or update common data, such as operating systems, application software, and cached data, once for the entire server 100. As another example of the shared peripheral resources managed by the peripheral resource nodes, the storage node 109 manages a remote BIOS 120, a console/universal asynchronous receiver-transmitter (UART) 121, and a data center management network 123. The network nodes 110 and 111 each manage one or more Ethernet uplinks connected to a data center network 114. The Ethernet uplinks are analogous to the uplink ports of a top-of rack switch and can be configured to connect directly to, for example, an end-of-row switch or core switch of the data center network 114. The remote BIOS 120 can be virtualized in the same manner as mass storage devices, NICs and other peripheral resources so as to operate as the local BIOS for some or all of the nodes of the server, thereby permitting such nodes to forgo implementation of a local BIOS at each node.

The fabric interface device of the compute nodes, the fabric interfaces of the peripheral resource nodes, and the fabric interconnect 112 together operate as a fabric 122 connecting the computing resources of the compute nodes with the peripheral resources of the peripheral resource nodes. To this end, the fabric 122 implements a distributed switching facility whereby each of the fabric interfaces and fabric interface devices comprises multiple ports connected to bidirectional links of the fabric interconnect 112 and operate as link layer switches to route packet traffic among the ports in accordance with deterministic routing logic implemented at the nodes of the server 100. Note that the term “link layer” generally refers to the data link layer, or layer 2, of the Open System Interconnection (OSI) model.

The fabric interconnect 112 can include a fixed or flexible interconnect such as a backplane, a printed wiring board, a motherboard, cabling or other flexible wiring, or a combination thereof. Moreover, the fabric interconnect 112 can include electrical signaling, photonic signaling, or a combination thereof. In some embodiments, the links of the fabric interconnect 112 comprise high-speed bi-directional serial links implemented in accordance with one or more of a Peripheral Component Interconnect-Express (PCIE) standard, a Rapid IO standard, a Rocket IO standard, a Hyper-Transport standard, a FiberChannel standard, an Ethernet-based standard, such as a Gigabit Ethernet (GbE) Attachment Unit Interface (XAUI) standard, and the like.

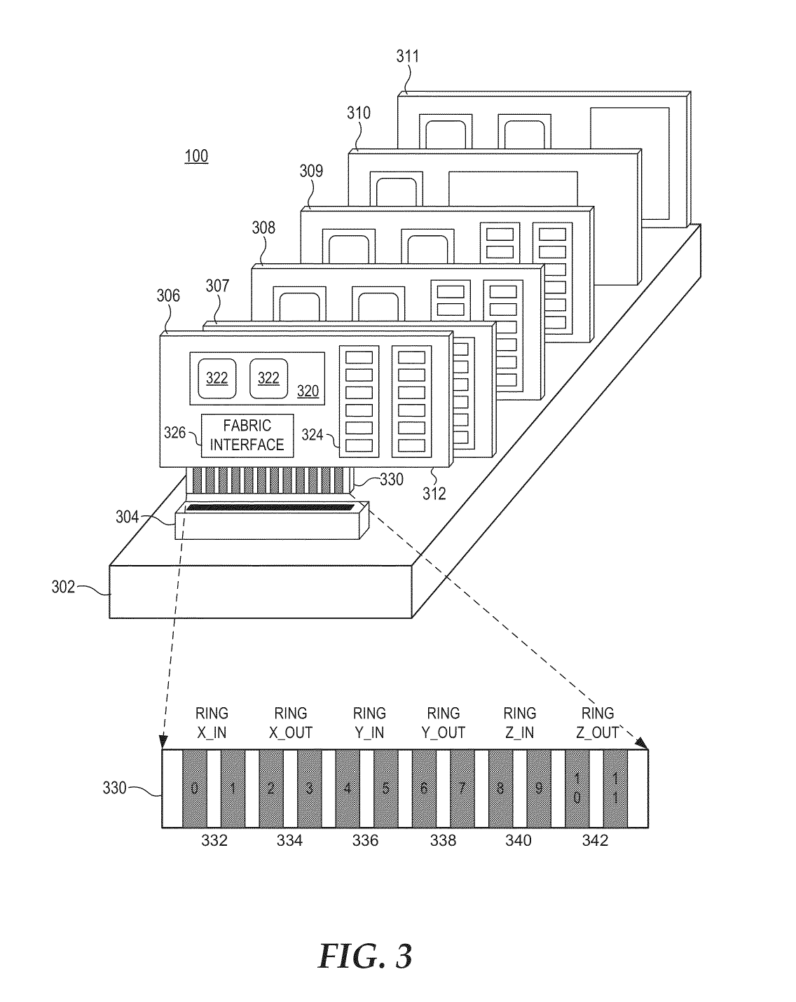

Although the FRUs implementing the nodes typically are physically arranged in one or more rows in a server box as described below with reference to FIG. 3, the fabric 122 can logically arrange the nodes in any of a variety of mesh topologies or other network topologies, such as a torus, a multi-dimensional torus (also referred to as a k-ary n-cube), a tree, a fat tree, and the like. For purposes of illustration, the server 100 is described herein in the context of a multi-dimensional torus network topology. However, the described techniques may be similarly applied in other network topologies using the guidelines provided herein.

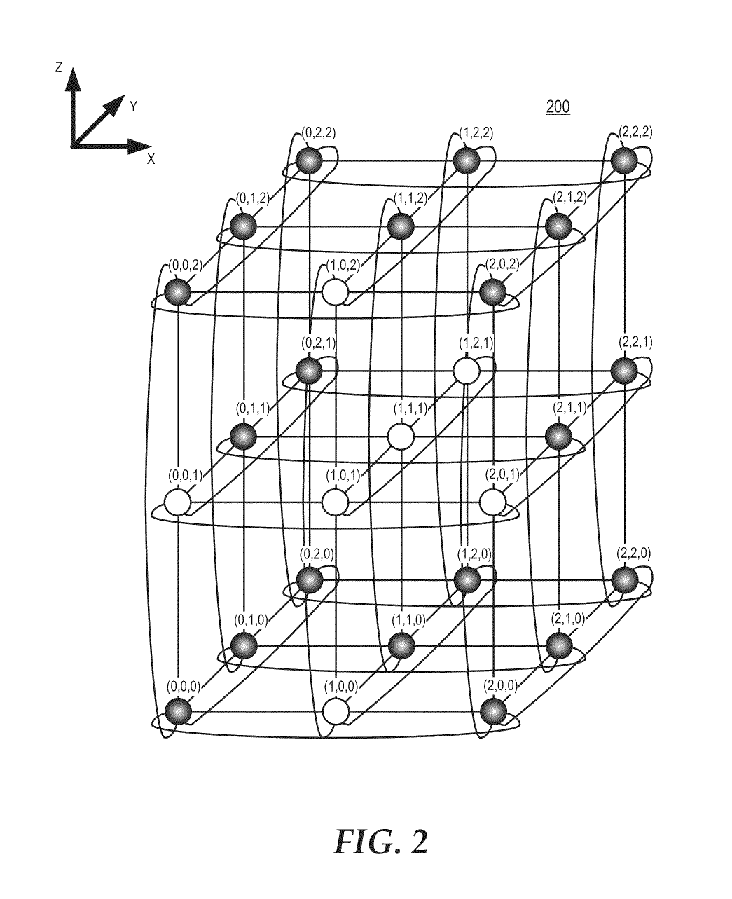

FIG. 2 illustrates an example configuration of the server 100 in a network topology arranged as a k-ary n-cube, or multi-dimensional torus, in accordance with some embodiments. In the depicted example, the server 100 implements a three-dimensional (3D) torus network topology (referred to herein as “torus network 200”) with a depth of three (that is, k=n=3). Accordingly, the server 100 implements a total of twenty-seven nodes arranged in a network of rings formed in three orthogonal dimensions (X,Y,Z), and each node is a member of three different rings, one in each of the dimensions. Each node is connected to up to six neighboring nodes via bidirectional serial links of the fabric interconnect 112 (see FIG. 1). The relative location of each node in the torus network 200 is identified in FIG. 2 by the position tuple (x,y,z), where x, y, and z represent the positions of the compute node in the X, Y, and Z dimensions, respectively. As such, the tuple (x,y,z) of a node also may serve as its address within the torus network 200, and thus serve as source routing control for routing packets to the destination node at the location represented by the position tuple (x,y,z). In some embodiments, one or more media access control (MAC) addresses can be temporarily or permanently associated with a given node. Some or all of such associated MAC address may directly represent the position tuple (x,y,z), which allows the location of a destination node in the torus network 200 to be determined and source routed based on the destination MAC address of the packet. As described in greater detail below, distributed look-up tables of MAC address to position tuple translations may be cached at the nodes to facilitate the identification of the position of a destination node based on the destination MAC address.

It will be appreciated that the illustrated X, Y, and Z dimensions represent logical dimensions that describe the positions of each node in a network, but do not necessarily represent physical dimensions that indicate the physical placement of each node. For example, the 3D torus network topology for torus network 200 can be implemented via the wiring of the fabric interconnect 112 with the nodes in the network physically arranged in one or more rows on a backplane or in a rack. That is, the relative position of a given node in the torus network 200 is defined by nodes to which it is connected, rather than the physical location of the compute node. In some embodiments, the fabric 122 (see FIG. 1) comprises a plurality of sockets wired together via the fabric interconnect 112 so as to implement the 3D torus network topology, and each of the nodes comprises a field replaceable unit (FRU) configured to couple to the sockets used by the fabric interconnect 112, such that the position of the node in torus network 200 is dictated by the socket into which the FRU is inserted.

In the server 100, messages communicated between nodes are segmented into one or more packets, which are routed over a routing path between the source node and the destination node. The routing path may include zero, one, or more than one intermediate node. As noted above, each node includes an interface to the fabric interconnect 112 that implements a link layer switch to route packets among the ports of the node connected to corresponding links of the fabric interconnect 112. In some embodiments, these distributed switches operate to route packets over the fabric 122 using source routing or a source routed scheme, such as a strict deterministic dimensional-order routing scheme (that is, completely traversing the torus network 200 in one dimension before moving to another dimension) that aids in avoiding fabric deadlocks. To illustrate an example of strict deterministic dimensional-order routing, a packet transmitted from the node at location (0,0,0) to location (2,2,2) would, if initially transmitted in the X dimension from node (0,0,0) to node (1,0,0) would continue in the X dimension to node (2,0,0), whereupon it would move in the Y plane from node (2,0,0) to node (2,1,0) and then to node (2,2,0), and then move in the Z plane from node (2,2,0) to node (2,2,1), and then to node (2,2,2). The order in which the planes are completely traversed between source and destination may be preconfigured and may differ for each node.

Moreover, as there are multiple routes between nodes in the torus network 200, the fabric 212 can be programmed for packet traffic to traverse a secondary path in case of a primary path failure. The fabric 212 also can implement packet classes and virtual channels to more effectively utilize the link bandwidth and eliminate packet loops, and thus avoid the need for link-level loop prevention and redundancy protocols such as the spanning tree protocol.

In some embodiments, certain types of nodes may be limited by design in their routing capabilities. For example, compute nodes may be permitted to act as intermediate nodes that exist in the routing path of a packet between the source node of the packet and the destination node of the packet, whereas peripheral resource nodes may be configured so as to act as only source nodes or destination nodes, and not as intermediate nodes that route packets to other nodes. In such scenarios, the routing paths in the fabric 122 can be configured to ensure that packets are not routed through peripheral resource nodes.

Various packet routing and techniques protocols may be implemented by the fabric 122. For example, to avoid the need for large buffers at switch of each node, the fabric 122 may use flow control digit (“flit”)-based switching whereby each packet is segmented into a sequence of flits. The first flit, called the header flit, holds information about the packet's route (namely the destination address) and sets up the routing behavior for all subsequent flit associated with the packet. The header flit is followed by zero or more body flits, containing the actual payload of data. The final flit, called the tail flit, performs some bookkeeping to release allocated resources on the source and destination nodes, as well as on all intermediate nodes in the routing path. These flits then may be routed through the torus network 200 using cut-through routing, which allocates buffers and channel bandwidth on a packet level, or wormhole routing, which allocated buffers and channel bandwidth on a flit level. Wormhole routing has the advantage of enabling the use of virtual channels in the torus network 200. A virtual channel holds the state needed to coordinate the handling of the flits of a packet over a channel, which includes the output channel of the current node for the next hop of the route and the state of the virtual channel (e.g., idle, waiting for resources, or active). The virtual channel may also include pointers to the flits of the packet that are buffered on the current node and the number of flit buffers available on the next node.

FIG. 3 illustrates an example physical arrangement of nodes of the server 100 in accordance with some embodiments. In the illustrated example, the fabric interconnect 112 (FIG. 1) includes one or more interconnects 302 having one or more rows or other aggregations of plug-in sockets 304. The interconnect 302 can include a fixed or flexible interconnect, such as a backplane, a printed wiring board, a motherboard, cabling or other flexible wiring, or a combination thereof. Moreover, the interconnect 302 can implement electrical signaling, photonic signaling, or a combination thereof. Each plug-in socket 304 comprises a card-edge socket that operates to connect one or more FRUs, such as FRUs 306-311, with the interconnect 302. Each FRU represents a corresponding node of the server 100. For example, FRUs 306-309 may comprise compute nodes, FRU 310 may comprise a network node, and FRU 311 can comprise a storage node.

Each FRU includes components disposed on a PCB, whereby the components are interconnected via metal layers of the PCB and provide the functionality of the node represented by the FRU. For example, the FRU 306, being a compute node in this example, includes a PCB 312 implementing a processor 320 comprising one or more processor cores 322, one or more memory modules 324, such as DRAM dual inline memory modules (DIMMs), and a fabric interface device 326. Each FRU further includes a socket interface 330 that operates to connect the FRU to the interconnect 302 via the plug-in socket 304.

The interconnect 302 provides data communication paths between the plug-in sockets 304, such that the interconnect 302 operates to connect FRUs into rings and to connect the rings into a 2D- or 3D-torus network topology, such as the torus network 200 of FIG. 2. The FRUs take advantage of these data communication paths through their corresponding fabric interfaces, such as the fabric interface device 326 of the FRU 306. The socket interface 330 provides electrical contacts (e.g., card edge pins) that electrically connect to corresponding electrical contacts of plug-in socket 304 to act as port interfaces for an X-dimension ring (e.g., ring-X_IN port 332 for pins 0 and 1 and ring-X_OUT port 334 for pins 2 and 3), for a Y-dimension ring (e.g., ring-Y_IN port 336 for pins 4 and 5 and ring-Y_OUT port 338 for pins 6 and 7), and for an Z-dimension ring (e.g., ring-Z_IN port 340 for pins 8 and 9 and ring-Z_OUT port 342 for pins 10 and 11). In the illustrated example, each port is a differential transmitter comprising either an input port or an output port of, for example, a PCIE lane. A skilled artisan will understand that a port can include additional TX/RX signal pins to accommodate additional lanes or additional ports.

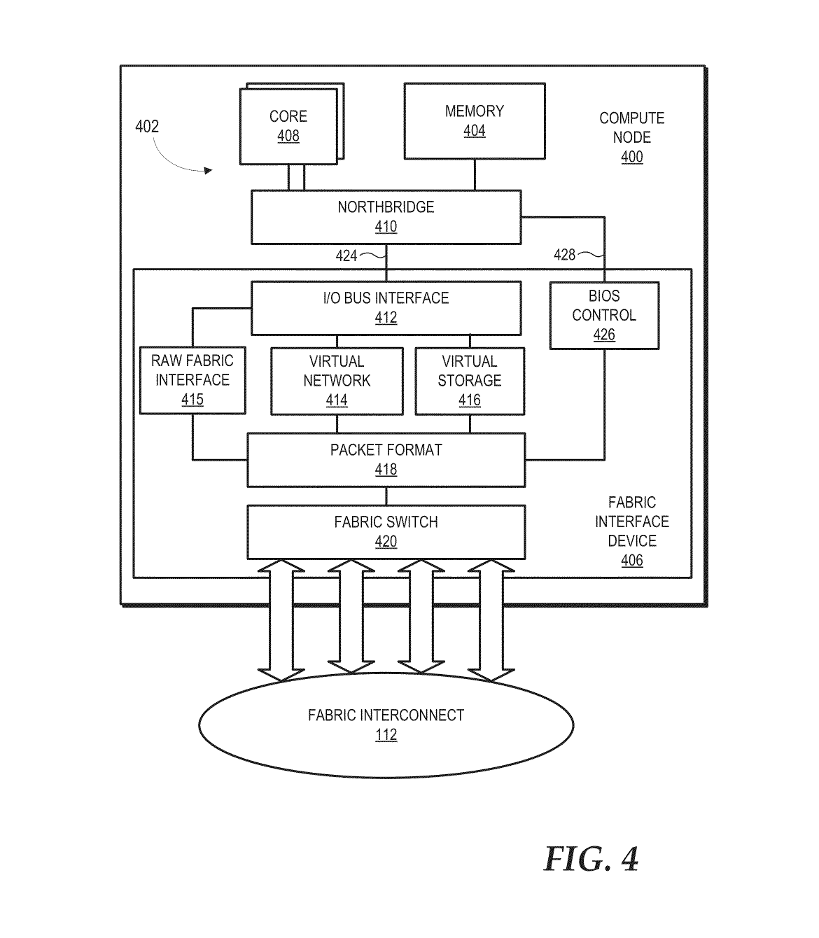

FIG. 4 illustrates a compute node 400 implemented in the server 100 of FIG. 1 in accordance with some embodiments. The compute node 400 corresponds to, for example, one of the compute nodes 101-106 of FIG. 1. In the depicted example, the compute node 400 includes a processor 402, system memory 404, and a fabric interface device 406 (corresponding to the processor 320, system memory 324, and the fabric interface device 326, respectively, of FIG. 3). The processor 402 includes one or more processor cores 408 and a northbridge 410. The one or more processor cores 408 can include any of a variety of types of processor cores, or combination thereof, such as a central processing unit (CPU) core, a graphics processing unit (GPU) core, a digital signal processing unit (DSP) core, and the like, and may implement any of a variety of instruction set architectures, such as an x86 instruction set architecture or an Advanced RISC Machine (ARM) architecture. The system memory 404 can include one or more memory modules, such as DRAM modules, SRAM modules, flash memory, or a combination thereof. The northbridge 410 interconnects the one or more cores 408, the system memory 404, and the fabric interface device 406. The fabric interface device 406, in some embodiments, is implemented in an integrated circuit device, such as an application-specific integrated circuit (ASIC), a field-programmable gate array (FPGA), mask-programmable gate arrays, gate arrays, programmable logic, and the like.

In a conventional computing system, the northbridge 410 would be connected to a southbridge, which would then operate as the interface between the northbridge 410 (and thus the processor cores 208) and one or local more I/O controllers that manage local peripheral resources. However, as noted above, in some embodiments the compute node 400 does not maintain local peripheral resources or their I/O controllers, and instead uses shared remote peripheral resources at other nodes in the server 100. To render this arrangement transparent to software executing at the processor 402, the fabric interface device 406 virtualizes the remote peripheral resources allocated to the compute node such that the hardware of the fabric interface device 406 emulates a southbridge and thus appears to the northbridge 410 as a local southbridge connected to local peripheral resources.

To this end, the fabric interface device 406 includes an I/O bus interface 412, a virtual network controller 414, a virtual storage controller 416, a packet formatter 418, and a fabric switch 420. The I/O bus interface 412 connects to the northbridge 410 via a local I/O bus 424 and acts as a virtual endpoint for each local processor core 408 by intercepting messages addressed to virtualized peripheral resources that appear to be on the local I/O bus 424 and responding to the messages in the same manner as a local peripheral resource, although with a potentially longer delay due to the remote location of the peripheral resource being virtually represented by the I/O bus interface 412.

While the I/O bus interface 412 provides the physical interface to the northbridge 410, the higher-level responses are generated by a set of interfaces, including the virtual network controller 414, the virtual storage controller 416, and a raw fabric interface 415. Messages sent over I/O bus 424 for a network peripheral, such as an Ethernet NIC, are routed by the I/O bus interface 412 to the virtual network controller 414, while messages for a storage device are routed by the I/O bus interface 412 to the virtual storage controller 416. The virtual network controller 414 provides processing of incoming and outgoing requests based on a standard network protocol such as, for example, an Ethernet protocol. The virtual network controller 414 translates outgoing and incoming messages between the network protocol and the raw fabric protocol for the fabric interconnect 112. Similarly, the virtual storage controller 416 provides processing of incoming and outgoing messages based on a standard storage protocol such as, for example, a serial ATA (SATA) protocol, a serial attached SCSI (SAS) protocol, a Universal Serial Bus (USB) protocol, and the like. The virtual storage controller 416 translates outgoing and incoming messages between the storage protocol and the raw fabric protocol for the fabric interconnect 112.

The raw fabric interface 415 provides processing of incoming and outgoing messages arranged according to the raw fabric protocol of the fabric interconnect 112. Accordingly, the raw fabric interface 415 does not translate received messages to another protocol, but may perform other operations such as security operations as described further herein. Because the raw fabric interface 415 does not translate received messages, communications via the interface can have a lower processing overhead and increased throughput than communications via the virtual network controller 414 and the virtual storage controller 416, at a potential cost of requiring execution of a specialized driver or other software at the processor 402.

After being processed by one of the virtual network controller 414, the virtual storage controller 416, or the raw fabric interface 415, messages are forwarded to the packet formatter 418, which encapsulates each message into one or more packets. The packet formatter 418 then determines the fabric address or other location identifier of the peripheral resource node managing the physical peripheral resource intended for the request. In some embodiments, the virtual network controller 414 and the virtual storage controller 416 each determine the fabric address for their corresponding messages based on an address translation table or other module, and provide the fabric address to the packet formatter 418. For messages provided to the raw fabric interface 415, the message itself will identify the raw fabric address. The packet formatter 418 adds the identified fabric address (referred to herein as the “fabric ID”) of each received message to the headers of the one or more packets in which the request is encapsulated and provides the packets to the fabric switch 420 of the NIC 419 for transmission.

As illustrated, the fabric switch 420 implements a plurality of ports, each port interfacing with a different link of the fabric interconnect 112. To illustrate using the 3×3 torus network 200 of FIG. 2, assume the compute node 400 represents the node at (1,1,1). In this example, the fabric switch 420 would have at least seven ports to couple it to seven bi-directional links: an internal link to the packet formatter 418; an external link to the node at (0,1,1); an external link to the node at (1,0,1), an external link to the node at (1,1,0), an external link to the node at (1,2,1), an external link to the node at (2,1,1), and an external link to the node at (1,1,2). Control of the switching of data among the ports of the fabric switch 420 is determined based on routing rules, which specifies the egress port based on the destination address indicated by the packet.

For responses to outgoing messages and other incoming message (e.g., messages from other compute nodes or from peripheral resource nodes), the process described above is reversed. The fabric switch 420 receives an incoming packet and routes the incoming packet to the port connected to the packet formatter 418 based on the deterministic routing logic. The packet formatter 418 then deencapsulates the response/request from the packet and provides it to one of the virtual network controller 414, the raw fabric interface 415, or the virtual storage controller 416 based on a type-identifier included in the message. The controller/interface receiving the message then processes the message and controls the I/O bus interface 412 to signal the request to the northbridge 410, whereupon the response/request is processed as though it were a message from a local peripheral resource.

For a transitory packet for which the compute node 400 is an intermediate node in the routing path for the packet, the fabric switch 420 determines the destination address (e.g., the tuple (x,y,z)) from the header of the transitory packet, and provides the packet to a corresponding output port identified by the deterministic routing logic.

As noted above, the BIOS likewise can be a virtualized peripheral resource. In such instances, the fabric interface device 406 can include a BIOS controller 426 connected to the northbridge 410 either through the local I/O interface bus 424 or via a separate low pin count (LPC) bus 428. As with storage and network resources, the BIOS controller 426 can emulate a local BIOS by responding to BIOS requests from the northbridge 410 by forwarding the BIOS requests via the packet formatter 418 and the fabric switch 420 to a peripheral resource node managing a remote BIOS, and then providing the BIOS data supplied in turn to the northbridge 410.

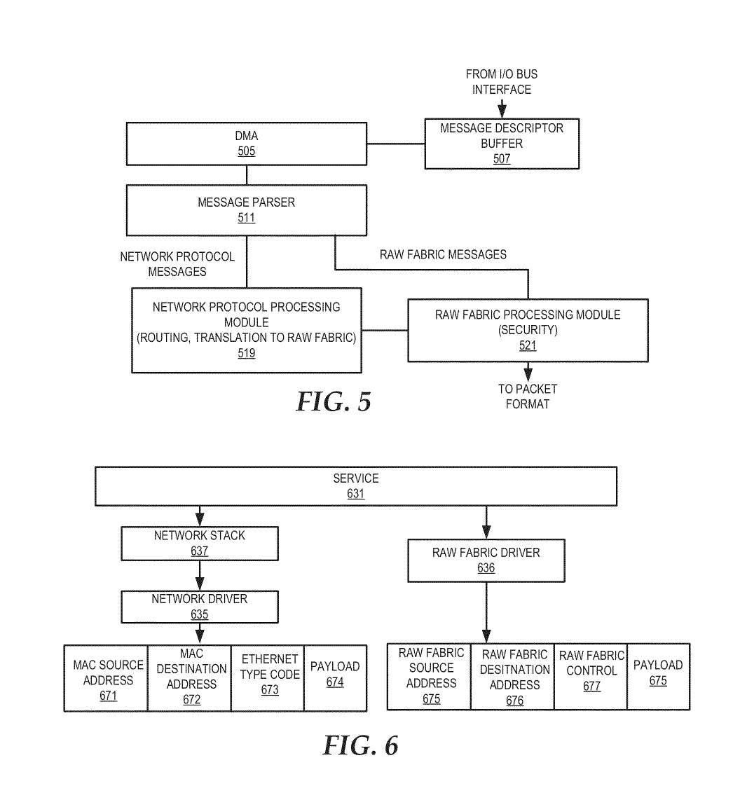

In some embodiments, to conserve circuit area and improve processing efficiency, the virtual network controller 414 and the raw fabric interface 415 share one or more modules to process received messages. An example of such sharing is illustrated at FIG. 5, which depicts a direct memory access module (DMA) 505, a message descriptor buffer 507, a message parser 511, a network protocol processing module (NPPM) 519, and a raw fabric processing module (RFPM) 521 in accordance with some embodiments. The DMA 505, message descriptor buffer 507, message parser 511, and RFPM 521 form a data path for processing of messages for the raw fabric interface 415, while the DMA 505, message descriptor buffer 507, message parser 511, NPPM 519, and RFPM 521 for a data path for processing of messages for the virtual network controller 414.

To illustrate, in order to communicate a message via the fabric interconnect 112, a device driver executing at the processor 402 stores a message descriptor at the message descriptor buffer 507, whereby the descriptor indicates the location at the memory 404 of the message to be sent. The message descriptor can also include control information for the DMA 505, such as DMA channel information, arbitration information, and the like. The message identified by a message descriptor can be formatted according to either of a standard network protocol (e.g. an Ethernet format) or according to the raw fabric protocol format, depending on the device driver that stored the message descriptor. That is, drivers for both the virtual network controller 414 and the raw fabric interface 415 can employ the message descriptor buffer 507 to store their descriptors.

The DMA 505 traverses the message descriptor buffer 507 either sequentially or according to a defined arbitration protocol. For each stored message descriptor, the DMA 505 retrieves the associated message from the memory 404 and provides it to the message parser 511. The message parser 511 analyzes each received message to identify whether the message is formatted according to the network protocol or according to the raw fabric protocol. The identification can be made, for example, based on the length of each destination address, whereby a longer destination address indicates the message is formatted according to the network protocol. In some embodiments, the identification is mad based on a flag in each descriptor indicating whether the corresponding message is formatted according to the network protocol or according to the raw fabric protocol. The message parser 511 provides messages formatted according to the network protocol to the NPPM 519, and provides messages formatted according to the raw fabric protocol to the RFPM 521. The DMA 505 can also store received messages to the memory 404.

The NPPM 519 translates each received message from the network protocol to the raw fabric protocol. Accordingly, the NPPM 519 translates the network address information of a received message to address information in accordance with the raw fabric protocol. To illustrate, in some embodiments the messages formatted according to the network protocol include media access control (MAC) addresses for the source of the message and the destination of the message. The NPPM 519 translates the source and destination MAC addresses to raw fabric addresses that can be used directly by the fabric interconnect 112 for routing, without further address translation. In some embodiments, the raw fabric addresses for the source and destination are embedded in the source and destination MAC addresses, and the NPPM 519 performs its translation by masking the MAC addresses to produce the raw fabric addresses. In some embodiments, translation of messages by the NPPM 519 includes Translation Control Protocol/Internet Protocol (TCP/IP) checksum generation, TCP/IP segmentation, and virtual local area network (VLAN) insertion. After translation, the NPPM 519 provides the messages in the raw fabric format to the RFPM 521.

The RFPM 521 processes raw fabric messages, received from either the NPPM 519 or directly from the message parser 511 to prepare the messages for packetization. In some embodiments the RFPM 521 performs security operations to ensure that each message complies with a security protocol of the fabric interconnect 112. For example, to prevent spoofing the security protocol may require the raw fabric source address in each message to match the raw fabric source address of the message's originating node. Accordingly, the RFPM 521 can compare the raw fabric source address of each received message to the raw fabric address of the compute node 400 and, in the event of a mismatch, perform remedial operations such as dropping the message, notifying another compute node, and the like. In some embodiments, the RFPM 521 forces fields of the header of a raw fabric message (such as the source address of the message and a virtual fabric tag that provides hardware level isolation to the fabric) to be fixed and not controllable by a driver or other software. In some embodiments the RFPM 521 automatically filters (e.g. drops) packets that do not meet defined or programmable criteria. For example, the RFPM 521 can filter using fields of a message such as a source address field, destination address field, virtual fabric tag, message type field, or any combination thereof. After completion of its processing operations, the RFPM 521 provides the processed messages to the packet formatter 318 for packetization and communication via the fabric interconnect 112.

FIG. 6 illustrates communication of messages via a set of drivers executing at the compute node 400 in accordance with some embodiments. In the illustrated example, the processor 402 executes a service 631, which can be a database management service, file management service, web page service, or any other service that can be executed at a server. In the course of its execution, the service 631 generates payload data to be communicated to other nodes via the fabric interconnect 112. In particular, the service 631 generates both payload data to be communicated via the virtual network interface 414 and messages to be communicated via the raw fabric interface 415. For payload data to be communicated via the virtual network interface 414, the processor 402 executes a network driver 635 that generates one or more network protocol messages incorporating the payload data. In the illustrated example of FIG. 6, the network protocol corresponds to an Ethernet protocol. The service 631 provides message data to a network stack 637 which is accessed by the network driver 635 to generate messages including a MAC source address field 671 indicating the MAC source address of the message, a MAC destination address field 672 indicating the MAC destination address of the message, an Ethernet type code field 673, indicating a type code for the message, and a payload field 674 to store the payload data.

For payload data to be communicated directly via the raw fabric interface 415, the processor 402 executes a raw fabric driver 636 that generates one or more raw fabric messages incorporating the payload data. Each raw fabric message includes a raw fabric source address field 675, a raw fabric destination address field 676, a raw fabric control field 677, and a payload field 678 to store the payload data. The source address field 675 and destination address fields 676 are formatted such that they can be directly interpreted by the fabric interconnect 112 for routing, without further translation. The control field 677 can include information to control, for example, the particular routing path that the message is to traverse to its destination. In some embodiments, the raw fabric message can include additional fields, such as virtual channel and traffic class fields, a packet size field that is not restricted to standard network protocol (e.g. Ethernet) sizes, and a packet type field.

For received packets, the flow is reversed. For example, for packets having messages formatted according to the network protocol, the network driver 635 provides the message data to the network stack 637 for subsequent retrieval by the service 631. For packets having messages formatted according to the raw fabric protocol, the raw fabric driver retrieves the message data and provides it to the service 631. In some embodiments, the compute node employs a programmable table that indicates type information associated with each interface. For each received packet, the compute node compares a type field of the packet with the programmable table to determine which of the raw fabric interface 415, virtual network controller 414, or virtual storage controller 416 is to process the received packet.

In the example of FIG. 6, messages formatted according to the raw fabric protocol do not pass through the network stack 637. In order to comply with the network protocol, the network stack 637 includes features that require additional processor overhead, such as features to reduce packet loss. Because messages formatted according to the raw fabric protocol bypass the network stack 637, processing overhead for these messages is reduced, improving throughput.

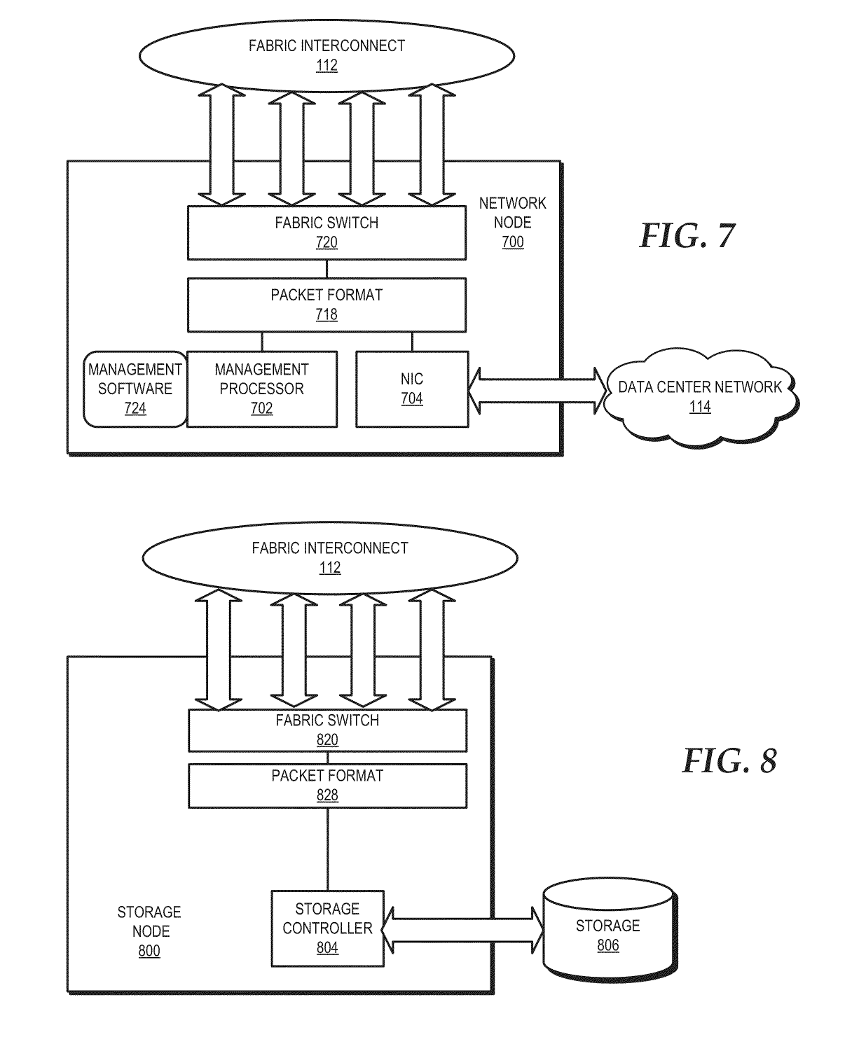

FIG. 7 illustrates a network node 700 implemented in the server 100 of FIG. 1 in accordance with some embodiments. The network node 700 corresponds to, for example, network nodes 110 and 111 of FIG. 1. In the depicted example, the network node 500 includes a management processor 702, a NIC 704 connected to, for example, an Ethernet network such as the data center network 114, a packet formatter 718, and a fabric switch 720. As with the fabric switch 420 of FIG. 4, the fabric switch 720 operates to switch incoming and outgoing packets among its plurality of ports based on deterministic routing logic. A packetized incoming message intended for the NIC 704 (which is virtualized to appear to the processor 402 of a compute node 400 as a local NIC) is intercepted by the fabric switch 720 from the fabric interconnect 112 and routed to the packet formatter 718, which deencapsulates the packet and forwards the request to the NIC 704. The NIC 704 then performs the one or more operations dictated by the message. Conversely, outgoing messages from the NIC 704 are encapsulated by the packet formatter 718 into one or more packets, and the packet formatter 718 determines the destination address using the distributed routing table 722 and inserts the destination address into the header of the outgoing packets. The outgoing packets are then switched to the port associated with the link in the fabric interconnect 112 connected to the next node in the fixed routing path between the network node 700 and the intended destination node.

The management processor 702 executes management software 724 stored in a local storage device (e.g., firmware ROM or flash memory) to provide various management functions for the server 100. These management functions can include maintaining a centralized master routing table and distributing portions thereof to individual nodes. Further, the management functions can include link aggregation techniques, such implementation of IEEE 802.3ad link aggregation, and media access control (MAC) aggregation and hiding.

FIG. 8 illustrates a storage node 800 implemented in the server 100 of FIG. 1 in accordance with some embodiments. The storage node 800 corresponds to, for example, storage nodes 107-109 of FIG. 1. As illustrated, the storage node 800 is configured similar to the network node 700 of FIG. 7 and includes a fabric switch 820 and a packet formatter 818, which operate in the manner described above with reference to the fabric switch 720 and the packet formatter 718 of the network node 700 of FIG. 7. However, rather than implementing a NIC, the storage node 600 implements a storage device controller 804, such as a SATA controller. A depacketized incoming request is provided to the storage device controller 804, which then performs the operations represented by the request with respect to a mass storage device 806 or other peripheral device (e.g., a USB-based device). Data and other responses from the peripheral device are processed by the storage device controller 804, which then provides a processed response to the packet formatter 818 for packetization and transmission by the fabric switch 820 to the destination node via the fabric interconnect 112.

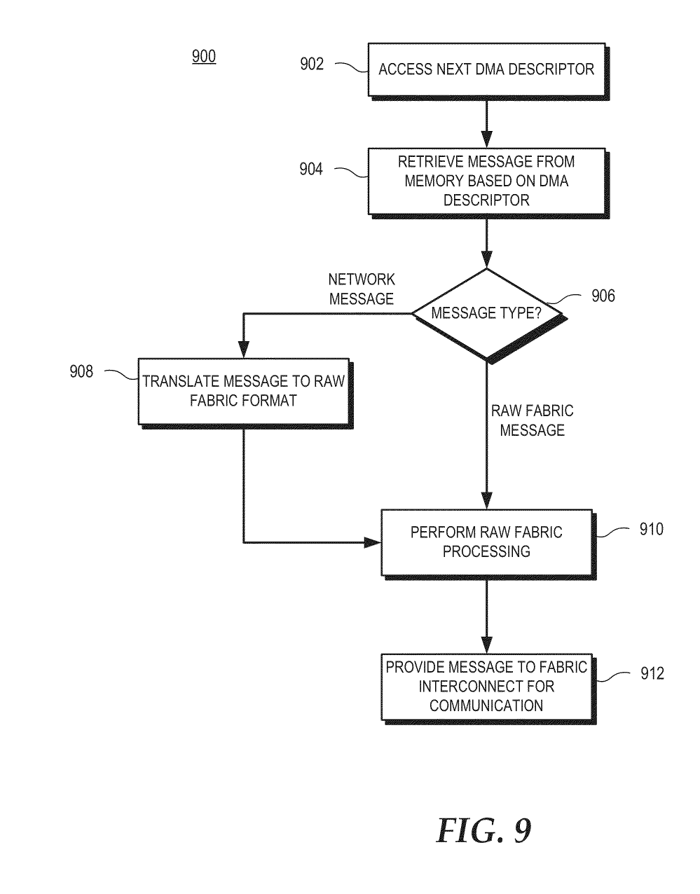

FIG. 9 is a flow diagram of a method 900 of using a raw fabric interface to send messages via a fabric interconnect in accordance with some embodiments. The method 900 is described with respect to an example implementation at the compute node 400 of FIG. 4 using the data paths illustrated at FIG. 5. At block 902 the DMA 505 retrieves the a message descriptor from the message descriptor buffer 507. Based on the retrieved descriptor, at block 904 the DMA 505 retrieves a message from the memory 404 and provides it to the message parser 511. At block 906 the message parser 511 determines whether the message is a network message formatted according to a standard network protocol or is a raw fabric message formatted according to the protocol used by the fabric interconnect 112. The message parser 511 provides network messages to the NPPM 519 and raw fabric messages to the RFPM 521. At block 908 the NPPM 519 translates network messages into raw fabric messages. At block 910 the RFPM 521 processes raw fabric messages (both those received from the NPPM 519 and those received directly from the message parser 511) so that they are ready for packetization and communication to the fabric interconnect 112. At block 912 the packetized messages are provided to the fabric interconnect 112 for communication to their respective destination nodes.

In some embodiments, at least some of the functionality described above may be implemented by one or more processors executing one or more software programs tangibly stored at a computer readable medium, and whereby the one or more software programs comprise instructions that, when executed, manipulate the one or more processors to perform one or more functions described above. In some embodiments, the apparatus and techniques described above are implemented in a system comprising one or more integrated circuit (IC) devices (also referred to as integrated circuit packages or microchips). Electronic design automation (EDA) and computer aided design (CAD) software tools may be used in the design and fabrication of these IC devices. These design tools typically are represented as one or more software programs. The one or more software programs comprise code executable by a computer system to manipulate the computer system to operate on code representative of circuitry of one or more IC devices so as to perform at least a portion of a process to design or adapt a manufacturing system to fabricate the circuitry. This code can include instructions, data, or a combination of instructions and data. The software instructions representing a design tool or fabrication tool typically are stored in a computer readable storage medium accessible to the computing system. Likewise, the code representative of one or more phases of the design or fabrication of an IC device may be stored in and accessed from the same computer readable storage medium or a different computer readable storage medium.

Electronic design automation (EDA) and computer aided design (CAD) software tools may be used in the design and fabrication of these IC devices. These design tools typically are represented as one or more software programs. The one or more software programs comprise code executable by a computer system to manipulate the computer system to operate on code representative of circuitry of one or more IC devices so as to perform at least a portion of a process to design or adapt a manufacturing system to fabricate the circuitry. This code can include instructions, data, or a combination of instructions and data. The software instructions representing a design tool or fabrication tool typically are stored in a computer readable storage medium accessible to the computing system. Likewise, the code representative of one or more phases of the design or fabrication of an IC device may be stored in and accessed from the same computer readable storage medium or a different computer readable storage medium.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

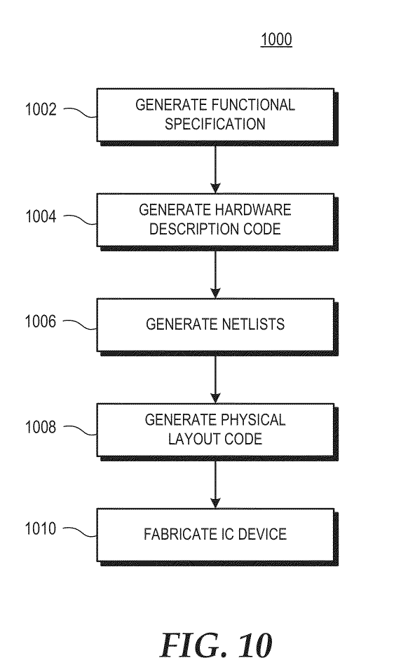

FIG. 10 is a flow diagram illustrating an example method 1000 for the design and fabrication of an IC device implementing one or more aspects. As noted above, the code generated for each of the following processes is stored or otherwise embodied in computer readable storage media for access and use by the corresponding design tool or fabrication tool.

At block 1002 a functional specification for the IC device is generated. The functional specification (often referred to as a micro architecture specification (MAS)) may be represented by any of a variety of programming languages or modeling languages, including C, C++, SystemC, Simulink™, or MATLAB™.

At block 1004, the functional specification is used to generate hardware description code representative of the hardware of the IC device. In at some embodiments, the hardware description code is represented using at least one Hardware Description Language (HDL), which comprises any of a variety of computer languages, specification languages, or modeling languages for the formal description and design of the circuits of the IC device. The generated HDL code typically represents the operation of the circuits of the IC device, the design and organization of the circuits, and tests to verify correct operation of the IC device through simulation. Examples of HDL include Analog HDL (AHDL), Verilog HDL, SystemVerilog HDL, and VHDL. For IC devices implementing synchronized digital circuits, the hardware descriptor code may include register transfer level (RTL) code to provide an abstract representation of the operations of the synchronous digital circuits. For other types of circuitry, the hardware descriptor code may include behavior-level code to provide an abstract representation of the circuitry's operation. The HDL model represented by the hardware description code typically is subjected to one or more rounds of simulation and debugging to pass design verification.

After verifying the design represented by the hardware description code, at block 1006 a synthesis tool is used to synthesize the hardware description code to generate code representing or defining an initial physical implementation of the circuitry of the IC device. In some embodiments, the synthesis tool generates one or more netlists comprising circuit device instances (e.g., gates, transistors, resistors, capacitors, inductors, diodes, etc.) and the nets, or connections, between the circuit device instances. Alternatively, all or a portion of a netlist can be generated manually without the use of a synthesis tool. As with the hardware description code, the netlists may be subjected to one or more test and verification processes before a final set of one or more netlists is generated.

Alternatively, a schematic editor tool can be used to draft a schematic of circuitry of the IC device and a schematic capture tool then may be used to capture the resulting circuit diagram and to generate one or more netlists (stored on a computer readable media) representing the components and connectivity of the circuit diagram. The captured circuit diagram may then be subjected to one or more rounds of simulation for testing and verification.

At block 1008, one or more EDA tools use the netlists produced at block 1006 to generate code representing the physical layout of the circuitry of the IC device. This process can include, for example, a placement tool using the netlists to determine or fix the location of each element of the circuitry of the IC device. Further, a routing tool builds on the placement process to add and route the wires needed to connect the circuit elements in accordance with the netlist(s). The resulting code represents a three-dimensional model of the IC device. The code may be represented in a database file format, such as, for example, the Graphic Database System II (GDSII) format. Data in this format typically represents geometric shapes, text labels, and other information about the circuit layout in hierarchical form.

At block 1010, the physical layout code (e.g., GDSII code) is provided to a manufacturing facility, which uses the physical layout code to configure or otherwise adapt fabrication tools of the manufacturing facility (e.g., through mask works) to fabricate the IC device. That is, the physical layout code may be programmed into one or more computer systems, which may then control, in whole or part, the operation of the tools of the manufacturing facility or the manufacturing operations performed therein.

As disclosed herein, in some embodiments, a server system includes a fabric interconnect to route messages formatted according to a raw fabric protocol; and a plurality of compute nodes coupled to the fabric interconnect to execute services for the server system, a respective compute node of the plurality of compute nodes including: a processor to generate a first message formatted according to a first standard protocol and a second message formatted according to the raw fabric protocol; a first interface to translate the first message from the first standard protocol to the raw fabric protocol and provide the translated message to the fabric interconnect; and a second interface to provide the second message to the fabric interconnect. In some aspects the first interface comprises a virtual network interface to translate the first message from a standard network protocol to the raw fabric protocol. In some aspects the standard network protocol comprises an Ethernet protocol. In some aspects the first compute node comprises a third interface to translate a third message from a second standard protocol to the raw fabric protocol. In some aspects the second standard protocol comprises a storage device protocol. In some aspects the first standard protocol comprises a network protocol. In some aspects the first interface and the second interface share a first processing module to process messages. In some aspects the first processing module comprises a direct memory access module (DMA) to retrieve and store messages at a memory of the first compute node. In some aspects the first interface and the second interface share a second processing module comprising a parser to identify if a retrieved message is formatted according to the standard protocol or the raw fabric protocol. In some aspects the server system includes a network node coupled to the fabric interconnect, the network node to communicate with a network, the first compute node to communicate with the network node via the first interface using messages formatted according to the first standard protocol. In some aspects the server system includes a storage node coupled to the fabric interconnect to communicate with one or more storage devices, the first compute node to communicate with the storage node via a third interface using messages formatted according to a second standard protocol.

In some embodiments a server system includes a fabric interconnect that routes messages according to a raw fabric protocol; and a plurality of compute nodes to communicate via the fabric interconnect and comprising a first compute node, the first compute node comprising: a processor; a first interface to virtualize the fabric interconnect as a network that communicates according to a network protocol; and a second interface that communicates a set of messages generated by the processor and formatted according to the raw fabric protocol to the fabric interconnect for routing. In some aspects the first compute node further comprises: a third interface to virtualize the fabric interconnect as a storage device that communicates according to a storage protocol. In some aspects the server system includes a storage node coupled to the fabric interconnect, the storage node comprising a storage device to communicate with the processor via the third interface. In some aspects the server system includes a network node coupled to the fabric interconnect, the network node comprising a network interface to transfer communications from a network to the processor via the first interface.

In some embodiments a method includes identifying, at a compute node of a server system having a plurality of compute nodes coupled via a fabric interconnect, a first message as being formatted according to either a first standard protocol or a raw fabric protocol used by the fabric interconnect to route messages; in response to the first message being formatted according to the first standard protocol, translating the first message to the raw fabric protocol and providing the translated message to the fabric interconnect; and in response to the first message being formatted according to the raw fabric protocol, providing the first message to the fabric interconnect without translation. In some aspects the standard protocol comprises a network protocol. In some aspects the method includes translating a second message formatted according to a second standard protocol to the raw fabric protocol and providing the second translated message to the fabric interconnect. In some aspects the second standard protocol comprises a storage protocol. In some aspects the method includes in response to the first message being formatted according to the first standard protocol, storing the message at a network stack; and in response to the first message being formatted according to the raw fabric protocol, bypassing the network stack.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed.

Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

What is claimed is:

1. A server system, comprising:
a fabric interconnect to route messages formatted according to a raw fabric protocol; and
a plurality of compute nodes coupled to the fabric interconnect to execute services for the server system, a respective compute node of the plurality of compute nodes comprising:
a processor to generate a first message formatted according to a first standard protocol and a second message formatted according to the raw fabric protocol;
a first interface to translate the first message from the first standard protocol to the raw fabric protocol and provide the translated message to the fabric interconnect; and
a second interface to provide the second message to the fabric interconnect.

2. The server system of claim 1, wherein the first interface comprises a virtual network interface to translate the first message from a standard network protocol to the raw fabric protocol.

3. The server system of claim 2, wherein the standard network protocol comprises an Ethernet protocol.

4. The server system of claim 1, wherein the first compute node comprises a third interface to translate a third message from a second standard protocol to the raw fabric protocol.

5. The server system of claim 4, wherein the second standard protocol comprises a storage device protocol.

6. The server system of claim 5, wherein the first standard protocol comprises a network protocol.

7. The server system of claim 1, wherein the first interface and the second interface share a first processing module to process messages.

8. The server system of claim 7, wherein the first processing module comprises a direct memory access module (DMA) to retrieve and store messages at a memory of the first compute node.

9. The server system of claim 8, wherein the first interface and the second interface share a second processing module comprising a parser to identify if a retrieved message is formatted according to the standard protocol or the raw fabric protocol.

10. The server system of claim 1, further comprising a network node coupled to the fabric interconnect, the network node to communicate with a network, the first compute node to communicate with the network node via the first interface using messages formatted according to the first standard protocol.

11. The server system of claim 10, further comprising a storage node coupled to the fabric interconnect to communicate with one or more storage devices, the first compute node to communicate with the storage node via a third interface using messages formatted according to a second standard protocol.

12. A server system, comprising:
a fabric interconnect that routes messages according to a raw fabric protocol; and
a plurality of compute nodes to communicate via the fabric interconnect and comprising a first compute node, the first compute node comprising:
a processor;
a first interface to virtualize the fabric interconnect as a network that communicates according to a network protocol; and
a second interface that communicates a set of messages generated by the processor and formatted according to the raw fabric protocol to the fabric interconnect for routing.

13. The server system of claim 12, wherein the first compute node further comprises:
a third interface to virtualize the fabric interconnect as a storage device that communicates according to a storage protocol.

14. The server system of claim 13, further comprising a storage node coupled to the fabric interconnect, the storage node comprising a storage device to communicate with the processor via the third interface.

15. The server system of claim 12, further comprising a network node coupled to the fabric interconnect, the network node comprising a network interface to transfer communications from a network to the processor via the first interface.

16. A method, comprising:
identifying, at a compute node of a server system having a plurality of compute nodes coupled via a fabric interconnect, a first message as being formatted according to either a first standard protocol or a raw fabric protocol used by the fabric interconnect to route messages;
in response to the first message being formatted according to the first standard protocol, translating the first message to the raw fabric protocol and providing the translated message to the fabric interconnect; and
in response to the first message being formatted according to the raw fabric protocol, providing the first message to the fabric interconnect without translation.

17. The method of claim 16, wherein the standard protocol comprises a network protocol.

18. The method of claim 16, further comprising translating a second message formatted according to a second standard protocol to the raw fabric protocol and providing the second translated message to the fabric interconnect.

19. The method of claim 18, wherein the second standard protocol comprises a storage protocol.

20. The method of claim 16, further comprising:
in response to the first message being formatted according to the first standard protocol, storing the message at a network stack; and
in response to the first message being formatted according to the raw fabric protocol, bypassing the network stack.
